(19) United States
(12) Patent Application Publication
(10) Pub. No.: US 2008/0131193 A1
(43) Pub. Date: Jun. 5, 2008

(54) Paint roller device for painting with self-supply means of several colors or types of paints including means of air supply to assist drying

(76) Inventors: Clara Cecilia Vega Botero, Medellin (CO); Edwin Miguel Quirama, Medellin (CO)

Correspondence Address: MCDERMOTT, WILL & EMERY, 4370 LA JOLLA VILLAGE DRIVE, SUITE 700, SAN DIEGO, CA, 92122, US

(21) Appl. No.: 11/818,060

(22) Filed: Jun. 11, 2007

(30) Foreign Application Priority Data
Nov. 30, 2006 (CO) 06-121197

(51) Int. Cl. B05C 17/00

(52) U.S. Cl. 401/197

(57) ABSTRACT

This invention refers to a paint roller device for painting with self-supply means of several colors or types of paints including means of air supply to assist drying. Particularly, this invention refers to a paint roller with paint self-supply, comprising paint storage and distribution means; transportation means for such paint; and a roller body for distributing said paint over the surface to be painted. Likewise, the device has air supply means for its projection over the surface and to assist in drying of the same, after the paint required has been applied. On its part, the device supplies the user with a variety of types or paint colors, to be spread over the surface to be treated, including drying means.

### BACKGROUND OF THE INVENTION

This application claims the benefit of priority of Colombian application serial No. 06-121197, filed Nov. 30, 2006, the entire contents of which are incorporated herein by reference.

The present invention relates generally to a painting device, and more specifically to a paint roller device.

The former state of the art reveals the utilization of mobile rollers for interior and exterior painting work in buildings. Such rollers are basically comprised by a cylinder wrapped by a plush or porous textile fabric or the like, to be soaked in paint, whose rotation axis bends to constitute a grip handle or that can also be mounted possibly over an extension over the handle end to facilitate its handling to paint surfaces over a certain height.

Professionally, the use of rotating rollers has become extensive, since it allows painting large surfaces in less time than with respect to the use of brushes.

The roller operation assumes a series of supplementary operations, which render a loss of time and energy of the operator, since soaking of the roller in paint is required using a tray designed therefore; following, the surface is painted with the need of supplying extra paint for the roller over and over again. These unnecessary operations increase the painting process time, since the paint roller must be fed regularly.

In order to further clarify the invention and its advantages, compared to the state of the art known, following is a description, with the aid of the drawings attached, of the possible ways of illustration which do not limit the application of the principles mentioned.

### SUMMARY OF INVENTION

This invention refers to a paint roller device for painting with self-supply means of several colors or types of paints including means of air supply to assist drying. Particularly, this invention refers to a paint roller with paint self-supply, comprising paint storage and distribution means; transportation means for such paint; and a roller body for distributing said paint over the surface to be painted. Likewise, the device has air supply means for its projection over the surface and to assist in drying of the same, after the paint required has been applied. On its part, the device supplies the user with a variety of types or paint colors, to be spread over the surface to be treated, including drying means.

### BRIEF DESCRIPTION OF THE DRAWINGS

FIG. 1 shows a schematic view including the paint storage and distribution means of the device of the herein invention.

FIG. 2 shows a side view of the device of the herein invention.

FIG. 3 shows a front view of the device of the herein invention.

### DETAILED DESCRIPTION OF THE INVENTION

The characteristics of the invention are disclosed in detail in the claims attached as well as in the additional advantages of the same and shall be better understood with the detailed description and the corresponding reference to the drawings attached thereto.

This invention refers to a paint roller device to paint with self-supply means of several paint types or colors, including the air supply means to assist the drying.

A first purpose of the herein invention is to an efficient painting device. Particularly, a main purpose of the herein invention is to create a device with self-supplying means of several paint types or colors, avoiding the need of having to feed regularly the paint roller.

An important purpose of the herein invention is implementing the use of air projection means to assist the drying of the treated surface.

The herein invention fulfills these needs and provides other related advantages.

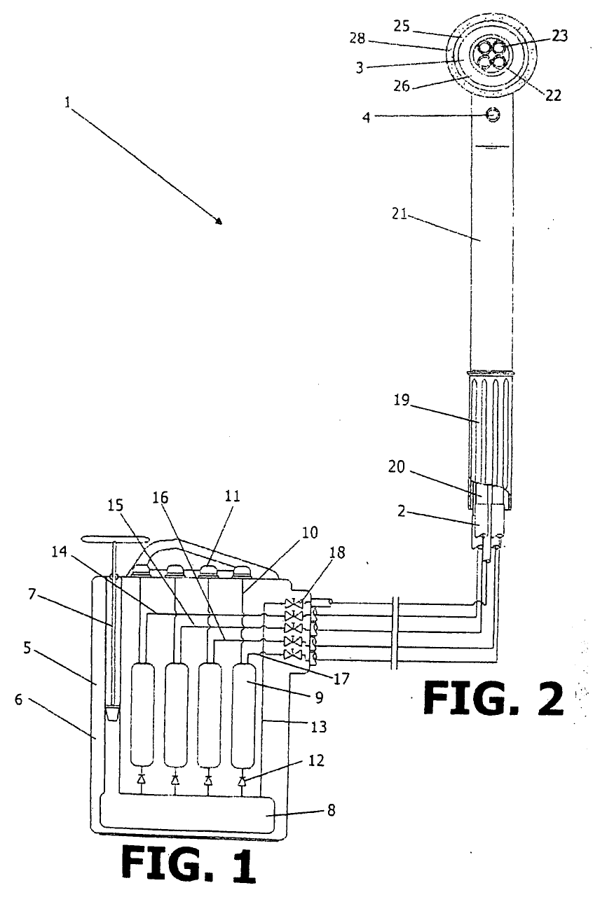

More particularly, in accordance with FIGS. 1 and 2, this invention refers to a paint roller, multiple paint self supply, comprising storage and distribution means 1; transportation means 2; and a roller body 3 for distributing said paint over the surface to be painted. Likewise, the device has air supply means 4 to project it over the surface and assist the drying of the same, after the required paint has been applied.

On its part, in accordance with FIG. 1, the storage and distribution means 1, comprise a container 5, which includes air pressurization means 6, including a manual pump 7 and a storage tank 8. The air tank 8 is supplied with pressurized air through said means of manual pump 7.

On the other hand, the container 5 comprises paint storage means 9. Said paint storage means 9 comprise four interior paint tanks, which are supplied through the paint supply means 10. Said paint supply means 10, are airtight closed, insulated from the environment through the plugs 11 on the outside of said container 5.

Such paint storage means 9 additionally are connected to the air storage tank 8, through one-direction valves 12. Such one-direction valves 12 guarantee the airflow in one direction from the air storage tank 8 to the paint storage means 9, preventing the flow of paint into the air tank 8.

On its part, five lines leave the container 5 towards the transportation means 2, to connect said container 5 with the roller body 3 and with the air supply means 4.

Thus, a first line comprises the first air line 13 and connects the air supply means 4 of the roller directly with the air tank 8.

On the other hand, the four remaining lines connect one by one, each of the four paint tanks to the paint storage means 9 with the roller body 3, wherein the second line 14 connects the roller 3 with the first paint tank; the third line 15 connects the roller 3 with the second paint tank; the fourth line 16 connects the roller 3 with the third paint tank; and the fifth line 17 connects the roller with the fourth paint tank.

At the outlet of the container 5, the five lines, in a preferred embodiment of the invention, comprise regulating valves 18, for opening and closing at the will of the operator, according to his/her needs.

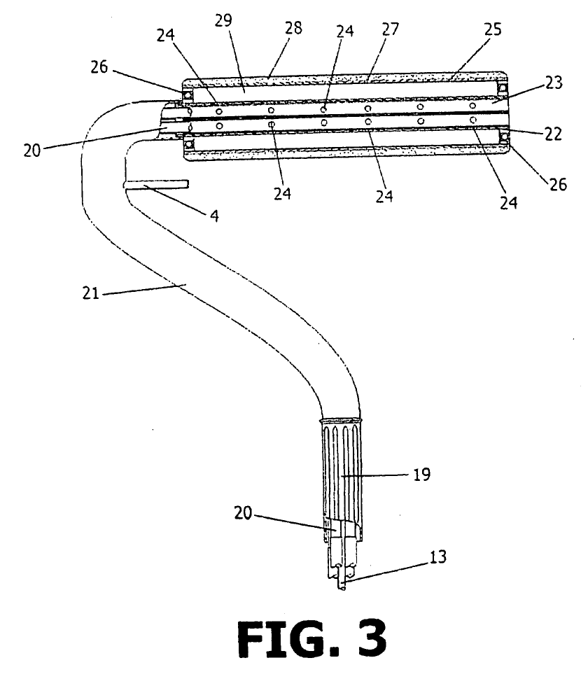

On its part, based on FIGS. 2 and 3, the device of the invention comprises handle for operation 19, where the five lines arrive, coming from the container 5. On its part, the handle 19 comprises a rigid tubular shaped structure in whose interior 20 five rigid tubings are exceeded, to which each of the five lines arriving from the container 5 connect to.

In a preferred embodiment of the invention, as from the container 5 and up to the handle 19, each of the five lines comprise a flexible hose in such a manner that allows the user mobility of the device.

The handle 19 is connected to the roller body 3 through a flexible tubular liner 21. Such five rigid tubings 20 go through the interior of the handle 19 and the interior of the flexible tubular liner 21 to reach the roller body 3. Said flexible tubular liner 21 additionally forms a sickle shape, until it reaches the roller body 3.

On the other hand, the air line 13 coming from the container 5 and that goes through the transportation means 2, stands out from the flexible tubular liner 21, adjacent to the slick curved shaped configuration, pointing towards the direction of the center of the roller body 3.

On its part, the roller body 3 comprises an interior pipe 22 hosting four tubings that supply the paint 23. Both the interior pipe 22 as well as the paint supply tubings 23, comprise a plurality of orifices 24 aligned among them. The flexible tubular liner 21 reaches said interior pipe, and each paint line of the four rigid tubings 20 reach each paint supply tubing 23, connecting the second line 14; the third line 15; the fourth line 16; and the fifth line 17 with the roller body 3.

Likewise, the roller body 3 comprises an exterior pipe 25 separate from the interior pipe 22 in an external way through bearings 26, over which the exterior pipe 25 can be relatively displaced with respect to the interior pipe 22. Similarly, the exterior pipe 25 comprises a plurality of borings 27 which connect the interior with the exterior of said pipe. Likewise, said exterior pipe 25 is coated with a plush or fabric disposed to be impregnated with paint.

Thus, an interior chamber 29 is formed, which, through the orifices in line 24 is filled with paint from the paint suppliers 23, which is supplied through the orifices 27 of the exterior pipe to the plush or fabric 28.

During use, the container 5, through the manual pump means, pressurizes the air tank 8. Such air tank 8 supplies pressurized air to the four paint tanks, pressurizing the paint tank, after having been fed by the supply means 10, closed by the plugs 11.

At the will of the operators, the regulating valves 18 can open or close each of the five lines, the air line and the four paint lines, regulating the flow towards the body roller.

The air goes out in the direction adjacent to the roller, while the paint line supplies the interior chamber 29, filling it up of paint, so that the same is fed through the orifices 27 to the plush 28.

Even though a special configuration has been illustrated, the manufacturing materials may vary, depending on the needs of the invention.

The invention provides a paint roller device for painting with self-supply means of several colors or types of paints including means of air supply to assist drying, characterized because it comprises paint storage and distribution means (1) comprised by a container (5) which includes air pressurization means (6), and paint storage means (9); transportation means (2), which include five lines, the first an air line and four paint lines; and a roller body (3) that receives the four paint lines as well as the air supply line (4) for its distribution. The paint roller device can be characterized because the air pressurization means (6), comprise a means of manual pump (7) and an air storage tank (8), wherein through such means of manual pump (7) the air tank (8) is supplied with pressurized air. The paint roller device can be characterized because the paint storage means (9) comprise four interior paint tanks, which are supplied through the paint supply means (10). The paint roller device can be characterized because the paint supply means (10), are air-tight closed, insulated from the environment through the plugs (11) on the outside of the container (5).

In addition, the paint roller device can be characterized because paint storage means (9) additionally are connected to the air storage tank (8), through one-direction valves (12). The paint roller device can be characterized because the one-direction valves (12) allow the air flow in one direction from the air storage tank (8) to the paint storage means (9). The paint roller device can be characterized because five lines leave the container (5) towards the transportation means (2), to connect the container (5) with the roller body (3) and with the air supply means 4. The paint roller device can be characterized because a first line comprises the first air line (13) and connects the air supply means (4) of the roller directly with the air tank (8). The paint roller device can be characterized because the four remaining lines connect one by one, each of the four paint tanks to the paint storage means (9) with the roller body (3), wherein the second line (14) connects the roller (3) with first paint tank; the third line (15) connects the roller (3) with the second paint tank; the fourth line (16) connects the roller (3) with the third paint tank; and the fifth line (17) connects the roller with the fourth paint tank.

Also, the paint roller device can be characterized because at the outlet of the container (5), the five lines comprise regulating valves (18), for opening and closing at the will of the operator, as the needs may require. The paint roller device can be characterized because it additionally comprises handle for operation (19), where the five lines arrive, coming from the container (5). The paint roller device can be characterized because the handle (19) comprises a rigid tubular shaped structure in whose interior (20) five rigid tubings are exceeded, to which each of the five lines arriving from the container (5) connect to. The paint roller device can be characterized because as from the container (5) and up to the handle (19), each of the five lines comprise a flexible hose. The paint roller device can be characterized because the handle (19) is connected to the roller body (3) through a flexible tubular liner (21). The paint roller device can be characterized because the five rigid tubings (20) go through the interior of the handle (19) and the interior of the flexible tubular liner (21) to reach the roller body (3). The paint roller device can be characterized because the flexible tubular liner (21) additionally forms a sickle shape, until it reaches the roller body (3). The paint roller device can be characterized because the air line (13) coming from the container (5) and that goes through the transportation means (2), stands out from the flexible tubular liner (21), adjacent to the slick curved shaped configuration, pointing towards the direction of the center of the roller body (3).

Furthermore, the paint roller device can be characterized because the roller body (3) comprises an interior pipe (22) hosting four tubings that supply the paint (23). The paint roller device can be characterized because the interior pipe (22) as well as the paint supply tubings (23), comprise a plurality of orifices (24) aligned among them. The paint roller device can be characterized because the interior pipe (22) connects with flexible tubular liner (21) and each paint supply tubing (23) connects to each line of the rigid tubings (20), connecting the second line (14); the third line (15); the fourth line (16); and the fifth line (17) with the roller body (3). The paint roller device can be characterized because the roller body (3) comprises an exterior pipe (25) separate from the interior pipe (22) in an external way through bearings (26), over which the exterior pipe (25) can be relatively displaced with respect to the interior pipe (22). The paint roller device can be characterized because the exterior pipe (25) comprises a plurality of borings (27) which connect the interior with the exterior of the pipe. The paint roller device can be characterized because the exterior pipe (25) is coated with a plush or fabric disposed to be impregnated with paint. The paint roller device can be characterized because the separation between exterior pipe (25) and the interior pipe (22) form an interior chamber (29), which, through the orifices in line (24), is filled with paint from the paint suppliers (23), which is supplied through the orifices (27) of the exterior pipe to the plush or fabric (28). It is understood that various combinations of the embodiments disclosed herein can be used in a paint roller device of the invention, as desired.

The invention additionally provides a paint roller device comprising a storage unit, the storage unit comprising a container which houses an air pressurization unit and a paint storage body; and a distribution unit, the distribution unit comprising a plurality of transportation lines, wherein at least one line is an air line and at least one line is a paint line, the distribution system further comprising a roller body that receives the plurality of transportation lines. In such a paint roller device, the air pressurization unit can comprise a manual pump and an air storage tank, wherein pumping the manual pump supplies the air storage tank with pressurized air. The paint roller device can include a paint storage body comprising a plurality of interior paint tanks, the paint tanks connecting to a corresponding plurality of supply channels, the supply channels delivering paint to the paint tanks. The paint roller can include each supply channel comprising an aperture that may be sealed using a plug, the plug sealing the aperture on the outside of the container. The paint roller device can include the paint storage body connected to the air storage tank by a one-directional valve.

Also, a paint roller device of the invention can include the air flowing through the one-directional valve from the air storage tank to the paint storage body. The paint roller device can include a plurality of transportation lines connecting the container to the roller body and to an air supply source. The paint roller device can include an air supply line connecting the air supply source directly to the air storage tank. The paint roller device can include paint lines connecting their corresponding paint tanks to the roller body. The paint roller device can include each transportation line comprising a regulating valve, the regulating valves being located at an outlet of the container, the regulating valves opening and closing the transportation lines. The paint roller device can include the distribution unit further comprising a handle, the transportation lines traveling through the handle to reach the roller body. The paint roller device can include a handle that is tubular, the interior of the handle comprising a plurality of rigid tubings corresponding to the plurality of transportation lines. The paint roller device can include the portion of the transportation lines located between the outlet of the container and the handle being flexible portions. The paint roller device can include a handle that is connected to the roller body with a flexible tube. The paint roller device can include a plurality of rigid tubings passing through the interior of the handle and the interior of the flexible tube to reach the roller body.

In addition, a paint roller device can include the portion of the flexible tube between the handle and the roller body being a curved portion. The paint roller can include an air line traveling outside the flexible tube, such that it is separate from the paint lines. The paint roller device can include a roller body comprising an interior pipe which receives a plurality of paint tubings. The paint roller device can include an interior pipe and the paint tubings comprising a plurality of orifices. The paint roller device can include paint lines that are connected to the roller body by the plurality of rigid tubings. The paint roller device can include a roller body comprising an exterior pipe, the exterior pipe surrounding the interior pipe, the exterior pipe being independently rotatable with respect to the interior pipe. The paint roller device can include an exterior pipe comprising a plurality of bores, through which a connection may be made to connect the interior pipe to the exterior pipe. The paint roller device can include an exterior pipe coated with a material capable of being impregnated with paint. The paint roller device can include a space between the exterior pipe and the interior pipe forming an interior chamber, wherein orifices may fill the interior chamber with paint, the orifices receiving paint from the paint tubings. It is understood that various combinations of the embodiments disclosed herein can be used in a paint roller device of the invention, as desired.

Only some of the preferred embodiments of the invention have been illustrated as way of example. With respect to the foregoing, it can bee seen that the construction of a paint roller, with self-supply of multiple paint, as well as the arrangements of its particular configuration may be chosen from a plurality of alternatives, without staying away from the spirit of the invention, pursuant to the following claims.

What is claimed is:

1. A paint roller device comprising:
a storage unit, the storage unit comprising a container which houses an air pressurization unit and a paint storage body; and
a distribution unit, the distribution unit comprising a plurality of transportation lines, wherein at least one line is an air line and at least one line is a paint line, the distribution system further comprising a roller body that receives the plurality of transportation lines.

2. The paint roller device of claim 1, wherein the air pressurization unit comprises a manual pump and an air storage tank, wherein pumping the manual pump supplies the air storage tank with pressurized air.

3. The paint roller device of claim 1, wherein the paint storage body comprises a plurality of interior paint tanks, the paint tanks connecting to a corresponding plurality of supply channels, the supply channels delivering paint to the paint tanks.

4. The paint roller device of claim 3, wherein each supply channel comprises an aperture that may be sealed using a plug, the plug sealing the aperture on the outside of the container.

5. The paint roller device of claim 4, wherein the paint storage body is connected to the air storage tank by a one-directional valve.

6. The paint roller device of claim 5, wherein the air flows through the one-directional valve from the air storage tank to the paint storage body.

7. The paint roller device of claim 6, wherein the plurality of transportation lines connects the container to the roller body and to an air supply source.

8. The paint roller device of claim 7, wherein the air supply line connects the air supply source directly to the air storage tank.

9. The paint roller device of claim 8, wherein the paint lines connect their corresponding paint tanks to the roller body.

10. The paint roller device of claim 9, wherein each transportation line comprises a regulating valve, the regulating valves being located at an outlet of the container, the regulating valves opening and closing the transportation lines.

11. The paint roller device of claim 1, wherein the distribution unit further comprises a handle, the transportation lines traveling through the handle to reach the roller body.

12. The paint roller device of claim 11, wherein the handle is tubular, the interior of the handle comprising a plurality of rigid tubings corresponding to the plurality of transportation lines.

13. The paint roller device of claim 11, wherein the portion of the transportation lines located between the outlet of the container and the handle are flexible portions.

14. The paint roller device of claim 11, wherein the handle is connected to the roller body with a flexible tube.

15. The paint roller device of claim 14, wherein the plurality of rigid tubings pass through the interior of the handle and the interior of the flexible tube to reach the roller body.

16. The paint roller device of claim 14, wherein the portion of the flexible tube between the handle and the roller body is a curved portion.

17. The paint roller device of claim 16, wherein the air line travels outside the flexible tube, such that it is separate from the paint lines.

18. The paint roller device of claim 1, wherein the roller body comprises an interior pipe which receives a plurality of paint tubings.

19. The paint roller device of claim 18, wherein the interior pipe and the paint tubings comprise a plurality of orifices.

20. The paint roller device of claim 19, wherein the paint lines are connected to the roller body by the plurality of rigid tubings.

21. The paint roller device of claim 20, wherein the roller body comprises an exterior pipe, the exterior pipe surrounding the interior pipe, the exterior pipe being independently rotatable with respect to the interior pipe.

22. The paint roller device of claim 21, wherein the exterior pipe comprises a plurality of bores, through which a connection may be made to connect the interior pipe to the exterior pipe.

23. The paint roller device of claim 22, wherein the exterior pipe is coated with a material capable of being impregnated with paint.

24. The paint roller device of claim 23, wherein the space between the exterior pipe and the interior pipe forms an interior chamber, wherein orifices may fill the interior chamber with paint, the orifices receiving paint from the paint tubings.
